(19) United States
(12) Patent Application Publication
(10) Pub. No.: US 2021/0165423 A1
(43) Pub. Date: Jun. 3, 2021

(54) MODULE FOR DRIVERLESS VEHICLE PRIORITY SYSTEM

(71) Applicant: CoKo Tech, LLC, Albuquerque, NM (US)

(72) Inventors: Christine Koski, Dallas, TX (US); Stephen Charles Cook, Albuquerque, NM (US)

(21) Appl. No.: 16/701,920

(22) Filed: Dec. 3, 2019

(51) Int. Cl. G05D 1/02; G07C 5/00; G05D 1/00; G08G 1/09; H04L 29/08

(52) U.S. Cl. CPC G05D 1/0287; G07C 5/008; H04L 67/12; G08G 1/09; G05D 1/0088

(57) ABSTRACT

In a priority module, a priority engine identifies at least one vehicle within a threshold proximity of a designated vehicle. The priority engine communicates internal priority data to the at least one vehicle within the threshold proximity. The priority engine receives external priority data from the at least one vehicles. Based on the internal and external priority data, the priority engine determines priority among each vehicle within the threshold proximity. The priority engine determines at least one priority parameter based on the determined priority of the designated vehicle and subsequently sends instructions to execute the priority parameters to the designated vehicle.

### FIELD OF THE INVENTION

The field of the invention is vehicle management systems.

### BACKGROUND

Given the increase in driver-independent vehicle aids being implemented in vehicles and driverless vehicles being developed and used in real world circumstances, establishing communication between or among vehicles is vital in creating a robust system that can accommodate to changing variables. Importantly, establishing communication between or among vehicles such that the one or more vehicles in communication change their respective behaviors based on the vehicles around them greatly enhances, broadens, and deepens the utility of driverless vehicles.

In conventional systems, vehicles simply react to their surroundings and rely on human intervention to cause changes in driving behavior that fit with the vehicle operator's priorities. For example, conventional cars can have a multitude of sensors, including, for example, distance sensors, light sensors, and any other sensors that allow conventional cars to react to various situational changes. These conventional sensors are limited to reacting defensively to keep vehicles in their lane, to automatically brake in response to slow downs, and various other reactive measures. However, conventional sensors are bound by the vehicle operator's actions.

In contrast, self-driving vehicles can autonomously make decisions to directly control vehicle movement without user input. Where self-driving vehicles can communicate with external entities, establishing a hierarchy of vehicles based on their respective permissions allows for a great degree of flexibility in controlling the driving behaviors of multiple vehicles. For example, establishing different tiers of cruising speeds on a highway assigned to particular lanes based on user preferences and instructing each vehicle to stay in their respective cruising speed category is possible if inter-vehicle communication and control are implemented. In another example, establishing heightened permissions for emergency vehicles can automatically cause non-prioritized vehicles to move to the side of the road when emergency vehicles are present.

However, the advancements in driverless vehicles technologies and the technological infrastructure supporting driverless vehicles will not be available to non-driverless vehicles without a means of communicating and reacting to driverless vehicles. For example, a conventional vehicle will not be able to automatically execute one or more actions required for a driverless vehicle system to function properly, such as automatically changing lanes to enter a prioritized lane. In these cases, conventional vehicles must be able to communicate with driverless vehicles and their corresponding technological infrastructure to take advantage of improved transportation technologies and to allow driverless and non-driverless vehicles to share the same spaces.

U.S. Pat. No. 6,807,464 to Yu discloses systems and methods to facilitate the passive distribution of information to vehicles. However, Yu does not disclose that the information is transmitted directly from vehicle to vehicle. Instead, Yu discloses a system where the vehicle receives information passively from non-vehicular entities. For example, Yu discloses that the disclosed systems and methods allow a user to receive information from a management system that indicates the times that parking is enforced at the location of the vehicle. Another example includes a traffic management system sending information to a driver that the vehicle can proceed.

Yu and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems to allow non-driverless vehicles to communicate directly with driverless vehicles to allow non-driverless vehicles to participate in driverless vehicle-based transportation infrastructures.

### SUMMARY OF THE INVENTION

Where self-driving vehicles can communicate with external entities, establishing a hierarchy of vehicles based on their respective permissions allows simultaneous controlling of multiple vehicles with a great degree of flexibility. For example, establishing different tiers of cruising speeds on a highway assigned to particular lanes based on user preferences and instructing each vehicle to stay in their respective cruising speed category is possible if inter-vehicle communication and control are implemented.

A module allowing a non-driverless vehicle to tap into a vehicle management system allows vehicle priority to be established among both non-driverless and driverless vehicles within a threshold proximity.

Among other things, the inventive subject matter provides apparatus, systems, and methods in which the vehicle management system identifies vehicles within designated parameters and establishes communications between non-driverless vehicles and driveless vehicles. Once communication is established, the inventive subject matter determines the priority of a designated vehicle associated with a priority module relative to the surrounding vehicles. Based on the priority established, the vehicle management system communicates one or more instructions to the designated vehicle to cause executing of the one or more instructions.

The present invention contemplates that a user of the designated vehicle executes the one or more instructions. However, the designated vehicle, despite being completely driverless, can directly execute one or more instructions in some cases. For example, a non-driverless vehicle with some level of autonomous control (e.g., automatic braking, lane keeping assistance, adaptive cruise control, etc.), can be instructed to automatically execute program instructions to change the behavior of the non-driverless vehicle.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a functional block diagram illustrating a distributed data processing environment.

FIG. 2 is a schematic of a method identifying vehicles priorities and determining priority parameters in a multi-vehicle system.

FIG. 3 is a schematic of a method of dynamically adjusting priority parameters based on one or more changes in priority.

FIG. 4 depicts a block diagram of components of the server computer executing the geolocation security engine within the distributed data processing environment of FIG. 1.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including facilitating the movement of driverless and non-driverless vehicles, establishing priorities/precedence among multiple vehicles, and allowing communication between or among vehicles.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

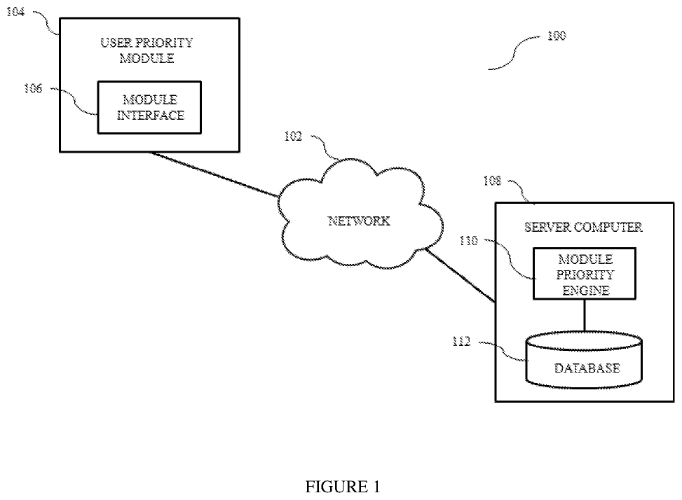

FIG. 1 is a functional block diagram illustrating a distributed data processing environment.

The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client priority module 104 and server computer 108, interconnected over network 102. Network 102 can include, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between priority module 104, server computer 108, and any other computing devices (not shown) within distributed data processing environment 100.

It is contemplated that priority module 104 can be any programmable electronic computing device capable of communicating with various components and devices within distributed data processing environment 100, via network 102. It is further contemplated that priority module 104 can execute machine readable program instructions and communicate with any devices capable of communication wirelessly and/or through a wired connection. Priority module 104 includes an instance of user interface 106.

User interface 106 provides a user interface to priority engine 110. Preferably, user interface 106 comprises a graphical user interface (GUI) or a web user interface (WUI) that can display one or more of text, documents, web browser windows, user option, application interfaces, and operational instructions. It is also contemplated that user interface can include information, such as, for example, graphics, texts, and sounds that a program presents to a user and the control sequences that allow a user to control a program.

In some embodiments, user interface is mobile application software. Mobile application software, or an “app,” is a computer program designed to run on smart phones, tablet computers, and any other mobile devices.

User interface 106 can allow a user to register with and configure priority engine 110 (discussed in more detail below) to enable a driver controlling a non-driverless vehicle to participate in a driverless vehicle priority system. It is contemplated that user interface 106 can allow a user to provide any information to priority engine 110. For example, a user can input authentication, priority parameters, and any other information that is used by priority engine 110. As used herein, “priority parameters” comprise any variables that can directly or indirectly control how a user participates in a vehicle priority system. For example, priority parameters can include special designations associated with a user that affect the user's priority level (e.g., handicap status, first responder status, etc.).

Server computer 108 can be a standalone computing device, a management server, a web server, a mobile computing device, or any other computing system capable of receiving, sending, and processing data.

It is contemplated that server computer 108 can include a server computing system that utilizes multiple computers as a server system, such as, for example, a cloud computing system.

In other embodiments, server computer 108 can be a computer system utilizing clustered computers and components that act as a single pool of seamless resources when accessed within distributed data processing environment 100.

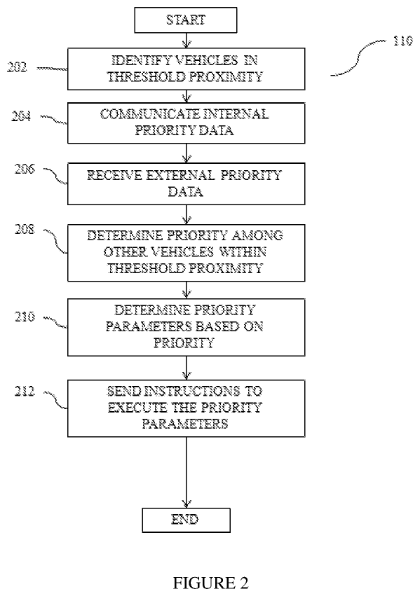

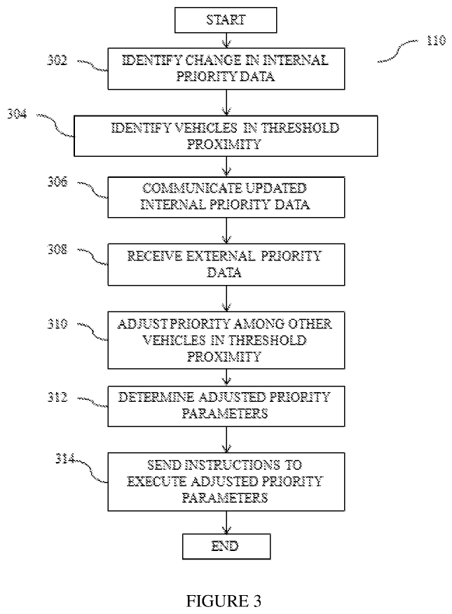

Priority engine 110 is depicted and described in more detail in FIG. 2 and FIG. 3.

Database 112 is a repository for data used by priority engine 110. In the depicted embodiment, priority engine 110 resides on server computer 108. However, database 112 can reside anywhere within a distributed data processing environment provided that priority engine 110 has access to database 112.

Data storage can be implemented with any type of data storage device capable of storing data and configuration files that can be accessed and utilized by server computer 108. Data storage devices can include, but are not limited to, database servers, hard disk drives, flash memory, and any combination thereof.

FIG. 2 is a schematic of a method identifying vehicle priorities and determining priority parameters for a non-driverless vehicle in a vehicle priority system as executed by priority engine 110.

Priority engine 110 identifies one or more vehicles within a threshold proximity (step 202).

As defined herein, a vehicle refers to any mode of transportation. For example, vehicles can include automobiles, planes, boats, and trains. It is contemplated that vehicles can also include driverless vehicles, conventional vehicles, and any combination of driverless and conventional vehicles (e.g., a conventional vehicle guiding a group of self-driving vehicles).

The threshold proximity can be set at any distance away from one or more points. In some embodiments, the threshold proximity can be greater than the maximum distance between one vehicle and another. For example, the threshold proximity can be set to include every vehicle in the world. In preferable embodiments, the threshold proximity is set to a distance to include vehicles within a proximity that meaningfully affects the flow of traffic around a designated vehicle. For example, the threshold proximity can be set to a 2000 feet radius around a car.

It is also contemplated that the threshold proximity can additionally or alternatively include non-distance-based variables. For example, the threshold proximity can include a designated geographical area, a common destination between or among multiple vehicles, and any other variable that allow priority engine 110 to establish priorities among one or more vehicles or groups of vehicles.

Preferably, priority engine 110 uses global positioning systems (GPS) to identify vehicles within a threshold proximity to a designated vehicle and/or geographical area. In some embodiments, the tracking is performed by an external entity. For example, priority engine 110 can use satellite imaging to determine the positions of multiple vehicles and then communicate the information to one or more vehicles. It is contemplated that the aforementioned type of tracking is advantageous in environments where routes are not clearly established and/or where inter-vehicle communication is difficult, including, for example, undeveloped, mountainous regions.

It is further contemplated that priority engine 110 can use any other spatial tracking system to determine the location of vehicles within a threshold proximity. For example, priority engine 110 can use altitude data when determining routes and spatial positioning of airplanes. In another example, priority engine 110 can use depth data when determining the spatial positioning of submarines.

In preferred embodiments, global positioning coordinates of multiple vehicles are gathered, consolidated, and used to identify vehicles within the threshold proximity. For example, global positioning coordinates of each vehicle in a city can be communicated to each other using conventional cellular data networks, gathered, and used to determine vehicles falling within a threshold proximity of a point of interest. It is also contemplated that any transmittable data can be communicated between or among vehicles, such as, for example, priority data and payment information.

In some embodiments, priority engine 110 can identify vehicles based on parameters. For example, priority engine 110 can isolate the commercial trucks within a threshold proximity rather than every category of vehicle when determining priority in weigh station for commercial vehicles.

Priority engine 110 communicates internal priority data (step 204).

Internal priority data comprises any data associated with the priority of a designated vehicle. For example, the designated vehicle can be a user's car. It is contemplated that the designated vehicle serves as the basis for data gathered and calculations executed by priority engine 110. For example, a user's car can serve as a geographical point that is used to determine which vehicles are in a threshold proximity to the user's vehicle.

Internal priority data can be communicated through any communications medium known in the art. For example, priority data, geographical location, type of vehicle, and speed can be communicated to from the designated vehicle to other vehicles through one or more wireless transmission mediums, including, for example, a cellular data network, satellite-based communication, and/or near field communications.

It is also contemplated that the vehicles are interconnected and receive data outside of their communications range by using a daisy-chain data transmission structure from vehicle to vehicle. For example, a vehicle can communicate and receive internal priority data from a vehicle falling outside one-mile range limit of a near field communications device by sending or receiving internal priority data between six cars that bridge a five-mile gap in increments of approximately one mile.

In some embodiments, one or more of the vehicles are connected by proxy of other devices. For example, a smart phone connected by near field communications to the vehicle can handle intervehicle communication using a cellular data network.

It is contemplated that vehicles can communicate directly with each other and/or through a central communication hub (e.g., a third-party service/device).

Priority engine 110 receives external priority data (step 206).

External priority data can comprise any data associated with factors outside of the designated vehicle. For example, external priority data can comprise data about every other vehicle within a threshold proximity of the designated vehicle. In another example, external priority data can include information received from third party services, including, for example, GPS services and emergency notification services.

It is contemplated that priority engine 110 can determine which vehicles around the designated vehicle are driverless and non-driverless. Where there are non-driverless vehicles within the threshold proximity, priority engine 110 can monitor the behavior of a non-driverless vehicles in order to anticipate and/or react to any non-anticipated actions. For example, if a driver of a non-driverless vehicles ignores an instruction for the driver to move the vehicle a lane over to a priority lane, priority engine 110 can automatically reorganize the vehicles within the system to react to the situational change. In the preceding example, priority engine 110 can also instruct non-vehicle-based entities to execute one or more actions based on the situational change, such as by instructing a toll payment system to prevent or remove a monetary charge on one or more users' accounts.

As with internal priority data, external priority data can be communicated through any communications medium known in the art. For example, priority data, geographical location, type of vehicle, and speed can be communicated from other vehicles to the designated vehicle through one or more wireless transmission mediums, including, for example, a cellular data network, satellite-based communication, and/or near field communications.

Priority engine 110 determines the priority of the designated vehicle among the other vehicles within the threshold proximity (step 208).

Priority engine 110 can utilize any available information to determine the priority of the designated vehicle relative to the other vehicles falling within the threshold proximity. For example, information can comprise one or more of: (1) vehicle routes, (2) vehicle speeds, (3) vehicle classifications, (4) internal priority data, (5) external priority data, (6) environmental data, and (7) driver data.

It is contemplated that priority engine 110 can use any type of analysis to determine the priority of one or more designated vehicles. For example, priority engine 110 can use mathematical optimization techniques, including, for example, heuristics/metaheuristics, constraint satisfaction, space mapping, combinatorial optimization, non-linear programming, disjunctive programming, and multi-objective optimization. However, priority engine 110 is not limited to any one or more optimization/analytical techniques, and can employ any optimization/analytical technique known in the art.

Priority engine 110 determines priority parameters for a designated vehicle based on the determined priority (step 210).

Priority parameters comprise any parameters that can be used to determine instructions sent to a user to control a vehicle based on one or more determined priorities, respectively.

In one embodiment, priority engine 110 selects a travel speed, travelling lane, a route, and a target travel time for a designated vehicle. For example, where the designated vehicle is an ambulance responding to child with moderate injuries, priority engine 110 can determine that the ambulance will travel at a minimum of 35 miles per hour, have access to all prioritized lanes (e.g. carpool lanes), travel the shortest route between the ambulance and the destination, and arrive at the destination before 5 minutes elapses. In another example, priority engine 110 can determine that a vehicle that paid a priority fee can travel an average of 10 miles per hour faster than non-prioritized traffic, have access to a toll lane, and travel the shortest route that does not interfere with emergency vehicles.

It is contemplated that priority parameters are communicated to a driver of a non-driverless vehicles through a sensory output device. Communication through a sensory output device can include, but is not limited to, auditory instructions sent through a speaker, textual instructions sent through a display, motion-based alerts through a vibrating device, and any combination thereof.

It is also contemplated that priority engine 110 can dynamically reassess priority data and determine priority parameters based on changing variables, which is discussed in more detail in FIG. 2. In the previous example, priority engine 110 can remove the access to all prioritized lanes upon receiving external priority data indicating a higher priority emergency occurring along the same route at the same time, such as, for example, a ten-vehicle car accident.

Priority engine 110 sends instructions to execute the priority parameters (step 212).

It is contemplated that priority engine 110 can send instructions to notify a user regarding the priority parameters through one or more notification mediums, including, for example, voice-prompts, textual notifications, graphical notifications, motion-based notification, and/or any other notification medium known in the art.

For example, priority engine 110 can send instructions to notify a user that access to a priority lane on the highway has been granted, and also directly update the GPS coordinates in the vehicle to update the indicated route.

FIG. 3 is a schematic of a method of dynamically adjusting priority parameters based on one or more changes in priority.

Priority engine 110 identifies a change in internal priority data (step 302). Preferably, priority engine 110 automatically detects one or more changes in the internal priority data. For example, priority engine 110 can automatically detect when a driver of a non-driverless vehicle ignores one or more instructions associated with the priority parameters.

In some embodiments, priority engine 110 receives changes in priority data when a user decides to send the data. For example, priority engine 110 can prompt a driver of a non-driverless vehicle to select whether to opt into a priority lane using a touch screen display on priority module 104. Upon receiving a selection of “Yes”, priority engine 110 can instruct the driver and any other vehicles nearby to change their respective behaviors to accommodate an additional vehicle in the priority lane.

Changes in internal priority data can include, but are not limited to, situational changes, user-initiated changes, and vehicular changes. For example, a vehicle can lose priority if an ambulance having a higher priority status is travelling on the same route within a threshold proximity. In another example, the user may decide to deactivate a priority status by opting out of paying a fee. In yet another example, a vehicle can lose priority when priority engine 110 detects a mechanical issue with the vehicle that prevents the vehicle from safely travelling on a highway.

Priority engine 110 identifies one or more vehicles within a threshold proximity (step 304).

As similarly discussed in step 202, priority engine 110 preferably uses global positioning systems (GPS) to identify vehicles within a threshold proximity to a designated vehicle and/or geographical area. In some embodiments, the tracking is performed by an external entity. However, it is contemplated that priority engine 110 can use any method of identifying vehicles within a threshold proximity known in the art.

In preferred embodiments, global positioning coordinates of multiple vehicles are gathered, consolidated, and used to identify vehicles within the threshold proximity. For example, global positioning coordinates of each vehicle in a city can be communicated to each other using conventional cellular data networks, gathered, and used to determine vehicles falling within a threshold proximity of a point of interest. It is also contemplated that any transmittable data can be communicated between or among vehicles, such as, for example, priority data and payment information.

It is contemplated that priority engine 110 uses the location of one or more designated vehicles to establish a center point and the outer boundaries of the threshold proximity. In embodiments where multiple vehicles are used to establish the center point, priority engine 110 can select a center point that best represents the multiple vehicles. For example, priority engine 110 can average the distances between three cars to determine a center point that falls in between each of the vehicles.

Priority engine 110 communicates updated internal priority data (step 306).

Internal priority data can be communicated through any communications medium known in the art. For example, priority data, geographical location, type of vehicle, and speed can be communicated to from the designated vehicle to other vehicles through one or more wireless transmission mediums, including, for example, a cellular data network, satellite-based communication, and/or near field communications.

It is also contemplated that the vehicles are interconnected and receive data outside of their communications range by using a daisy-chain data transmission structure, in which data is transmitted from vehicle to vehicle. For example, a vehicle can communicate and receive internal priority data from a vehicle falling outside one-mile range limit of a communications device by sending or receiving internal priority data between six cars that bridge a five-mile gap in increments of approximately one mile.

Using a daisy-chain data transmission structure is especially advantageous in situations where conventional wireless communications mediums are impractical or not possible. The daisy-chain transmission structure is not limited to a linear progression. For example, the daisy chain transmission structure can resemble a web where data is transmitted between more than two vehicles at a time.

In some embodiments, one or more of the vehicles can be connected by proxy of independent wireless devices. For example, a smart phone connected by near field communications to the vehicle can handle intervehicle communication using a cellular data network.

Priority engine 110 receives external priority data (step 308).

As similarly discussed in step 106, external priority data can be communicated through any communications medium known in the art. It is contemplated that the external priority data can include all, part, or none of the external priority data collected in a prior instance.

In a closed system, the external priority data can comprise the data from the same group of vehicles. For example, priority engine 110 can receive the external priority data from maintenance vehicles for a closed business campus.

In a partially open system, the external priority data can comprise data from a pre-designated group as well as a variable group of vehicles. For example, priority engine 110 can receive the external priority data from a non-variable group of maintenance vehicles and a variable group of customer vehicles driving on the business campus.

In an open system, the external priority data can comprise data from a variable group of vehicles. For example, priority engine 110 can receive the external priority data from a highly-variable group of vehicles surrounding a designated vehicle on a public highway.

Priority engine 110 adjusts the priority of the designated vehicle among the other vehicles within the threshold proximity (step 310).

As discussed similarly in step 108, priority engine 110 can utilize any available information to adjust the priority of the designated vehicle relative to the other vehicles falling within the threshold proximity. It is also contemplated that priority engine 110 can use any type of analysis to adjust the priority of one or more designated vehicles.

Priority engine 110 determines adjusted priority parameters (step 312).

It is contemplated that priority engine 110 can alter preexisting priority parameters and create new priority parameters depending on situation. Where the situation within the threshold proximity remains substantially similar or the same, priority engine 110 can make one or more adjustments to the previously determined priority parameters. For example, priority engine 110 can allow the top speed of a designated vehicle 10 miles per hour faster in response to a reduction in traffic and corresponding increase in average travel speed.

Additionally, priority engine 110 can create new priority parameters based on a change in the situation that requires a new priority parameter. For example, priority engine 110 can create a new priority parameter that allows a designated vehicle to travel in a priority lane that became available after the initial priority parameters were determined.

However, it is contemplated that priority engine 110 can change any variable associated with the behavior of the designated vehicle in response to any changes in travel conditions.

Priority engine 110 sends instructions to execute the adjusted priority parameters (step 314).

Preferably, priority engine 110 sends instruction to execute the adjusted priority parameters wirelessly to a designated vehicle. For example, priority engine 110 can use a conventional cellular data network, a wireless fidelity-based network, a satellite transmission medium, and/or a radio transceiver-based system.

However, it is contemplated that priority engine 110 can use any communications medium known in the art.

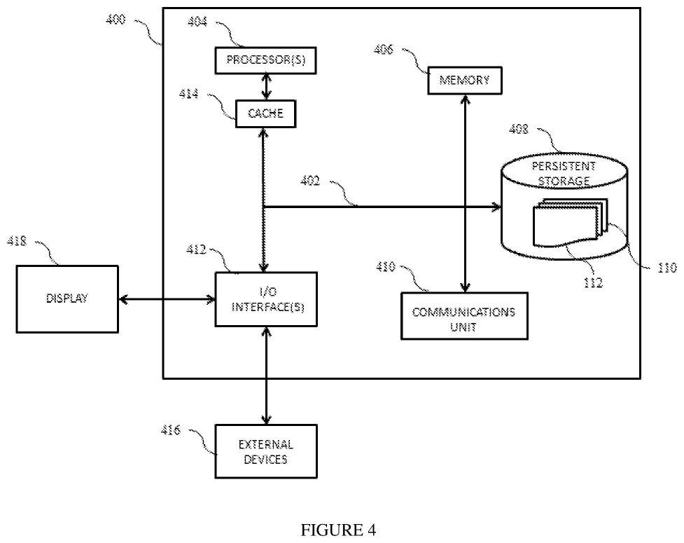

FIG. 4 depicts a block diagram of components of computer system 400 executing the program instructions associated with priority module 104 within the distributed data processing environment 100 of FIG. 1. FIG. 4 is not limited to the depicted embodiment. Any modification known in the art can be made to the depicted embodiment.

In one embodiment, the computer includes processor(s) 404, cache 414, memory 406, persistent storage 408, communications unit 410, input/output (I/O) interface(s) 412, and communications fabric 402.

Communications fabric 402 provides a communication medium between cache 414, memory 406, persistent storage 408, communications unit 410, and I/O interface 412. Communications fabric 402 can include any means of moving data and/or control information between computer processors, system memory, peripheral devices, and any other hardware components.

Memory 406 and persistent storage 408 are computer readable storage media. As depicted, memory 406 can include any volatile or non-volatile computer storage media. For example, volatile memory can include dynamic random access memory and/or static random access memory. In another example, non-volatile memory can include hard disk drives, solid state drives, semiconductor storage devices, a read-only memory (ROM), an erasable programmable read-only memory (EPROM), a flash memory, and any other storage medium that does not require a constant source of power to retain data.

In one embodiment, memory 406 and persistent storage 408 is random access memory and a hard drive hardwired to priority module 104, respectively. For example, priority module 104 can be a computer executing the program instructions of priority engine 110 communicatively coupled to a solid state drive and DRAM.

In some embodiments, persistent storage 408 is removable. For example, persistent storage 308 can be a thumb drive or a card with embedded integrated circuits.

Communications unit 410 provide communication with other data processing systems or devices, including data resources used by priority module 104. For example, communications unit 410 can comprise multiple network interface cards. In another example, communications unit 410 can comprise physical and/or wireless communication links.

It is contemplated that priority engine 110, database 112, and any other programs can be downloaded to persistent storage 408 using communications unit 410.

In a preferred embodiment, communications unit 410 comprises a global positioning satellite (GPS) device, a cellular data network communications device, and short to intermediate distance communications device (e.g., Bluetooth®, near-field communications, etc.). It is contemplated that communications unit 410 allows priority module 104 to communicate with other priority modules 104 associated with driverless and/or non-driverless cars in a vehicle priority system.

Display 418 is contemplated to provide a mechanism to display information from priority engine 110 through priority module 104. In preferred embodiments, display 318 has additional functionalities. For example, display 418 can be a pressure-based touchscreen or a capacitive touchscreen.

In yet other embodiments, display 418 is a combination of sensory output devices, such as, for example, a speaker that communicates information to a user and/or a vibration/haptic feedback mechanism. For example, display 418 can be a combination of a touchscreen in the dashboard of a car, a car speaker system, and a vibrating bracelet worn by a user to communicate information through a series of vibrations.

It is contemplated that display 418 does not need to be physically hardwired components and can, instead, be a collection of different devices that cooperatively communicate information to a user.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something designated from the group consisting of A, B, C . . . and N, the text should be interpreted as requiring only one element from the group, not A plus N, or B plus N, etc.

What is claimed is:

1. A priority module enabling a non-driverless vehicle to participate in a driverless priority system, comprising:
the priority module comprising a processor and software instructions that, when executed by the processor, program the processor to perform the following steps:
identifying a first set of vehicles within a threshold proximity of a designated vehicle;
communicating a first set of priority data of the designated vehicle with the first set of vehicles within the threshold proximity;
receiving a second set of priority data from the first set of vehicles;
determining the priority of the designated vehicle among the first set of vehicles;
determining a priority parameter that controls the behavior of the designated vehicle; and
sending the priority parameter to the designated vehicle, wherein the designated vehicle executes an action in response to receiving the priority parameter.

2. The priority module of claim 1, wherein the first set of priority data comprises data used to determine one or more priority parameters associated with the designated vehicle.

3. The priority module of claim 2, wherein the second set of priority data comprises data used to determine one or more priority parameters associated with the first set of vehicles.

4. The priority module of claim 1, wherein the priority parameter is selected from the group consisting of: a travel speed, a travelling lane, a route, and a target travel time.

5. The priority module of claim 1, wherein the priority module further performs the steps of:
identifying a change in the first set of priority data, wherein the change results in a second set of priority data;
identifying a second set of vehicles within the threshold proximity of the designated vehicle;
communicating the second set of priority data with the second set of vehicles within the threshold proximity;
receiving a third set of priority data from the second set of vehicles;
determining the priority of the designated vehicle among the second set of vehicles;
determining updated priority parameters that control the behavior of the designated vehicle; and
sending the updated priority parameter to the designated vehicle for execution.

6. The priority module of claim 5, wherein the first set of vehicles and the second set of vehicles overlap.

7. The priority module of claim 5, wherein the priority parameter is selected from the group consisting of: a travel speed, a travelling lane, a route, and a target travel time.
